(19) United States
(12) Patent Application Publication
(10) Pub. No.: US 2003/0196148 A1
(43) Pub. Date: Oct. 16, 2003

(54) System and method for peer-to-peer monitoring within a network

(76) Inventors: Carol Harrisville-Wolff, Louisville, CO (US); Jeff S. Demoff, Erie, CO (US); Alan S. Wolff, Louisville, CO (US)

Correspondence Address: HOGAN & HARTSON LLP, ONE TABOR CENTER, SUITE 1500, 1200 SEVENTEEN ST., DENVER, CO, 80202, US

(21) Appl. No.: 10/121,756

(22) Filed: Apr. 12, 2002

(51) Int. Cl. H04B 1/74

(52) U.S. Cl. 714/47

(57) ABSTRACT

A system and method for monitoring within a peer-to-peer network is disclosed. A peer-to-peer network includes peer machines coupled together without the use of a central processor. Each peer machine is able to monitor the other peer machines within the network and to perform failure recovery operations in the event a peer machine fails. A ping command is sent to every peer machine within the network using a peer protocol on the peer machine. If a response is received at the sending peer machine, then the responding peer machine is operating. If no response is received, a failure may have occurred and the sending peer machine can take corrective action, such alerting a system administrator or restarting the failed machine. The use of the peer monitoring reduces the need for central monitoring and prevents the network from having a single point of failure for monitoring activities.

### BACKGROUND OF THE INVENTION

1. Field of the Invention

The present invention relates to networks for exchanging data and information between peer machines and, more particularly, the present invention relates to a system and method for monitoring the status of the peer machines within a network using peer-to-peer techniques.

2. Discussion of the Related Art

Network availability is an issue of increasing importance. A typical network system probably includes client systems, such as computers, coupled a central server. The client systems can exchange information to each other, or facilitate centralized document retrieval and other services. When the network is down, however, these services are not available. Thus, high availability of the network allows for better information exchange, document retrieval, application execution, and the like.

For the administrator of a network, network monitoring services and tools rely upon the traditional client-server model. The monitoring service, or tool, resides on a single host machine or proxy server to perform monitoring activities against the other machines, or client systems, within the network. Problems may occur if the central server or host goes down. The entire network and its monitoring activities may be at risk.

For example, if the central server goes down because of a power surge or network outage, then the webservers also may go down for the same reasons. Because the machine hosting the monitoring services is down, the system administrator may not know about problem with the webservers until customers or clients start complaining, or there is no access to the network services. A potential problem with the above-described network is having a single point of failure in the monitoring systems. Backup or redundant servers or machines may be placed in the network, but these solutions may be cost prohibitive and require reconfiguration of the network. A third party also may be tasked with network monitoring, but this solution may not be feasible for small companies or secure networks.

### SUMMARY OF THE INVENTION

Accordingly, the present invention is directed to a system, method, and network for monitoring a peer-to-peer network having a plurality of peer machines.

According to a disclosed embodiment, a system for monitoring a network having a plurality of peer machines is disclosed. The system includes a peer machine from the plurality of peer machines that has a peer monitoring protocol. The system also includes a ping command. The peer machine sends the ping command to the plurality of peer machines. The system also includes a failure recovery state for the peer machine that is implemented according to the ping command.

According to another embodiment, a method for monitoring a peer-to-peer network is disclosed. The method includes executing a peer monitoring protocol on a first peer machine within the network. The method also includes sending a ping command to a second peer machine from the peer monitoring protocol. The method also includes determining whether the second peer machine is available according to a response from the ping command.

Additional features and advantages of the invention will be set forth in the disclosure that follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 illustrates a peer-to-peer network in accordance with an embodiment of the present invention.

FIG. 2 illustrates a network performing monitoring operations in accordance with an embodiment of the present invention.

FIG. 3 illustrates a flowchart for monitoring a peer-to-peer network in accordance with an embodiment of the present invention.

FIG. 4 illustrates a flowchart for failure recovery in accordance with an embodiment of the present invention.

### DETAILED DESCRIPTION OF THE PREFERRED EMBODIMENTS

Reference will now be made in detail to the preferred embodiment of the present invention, examples of which are illustrated in the accompanying drawings.

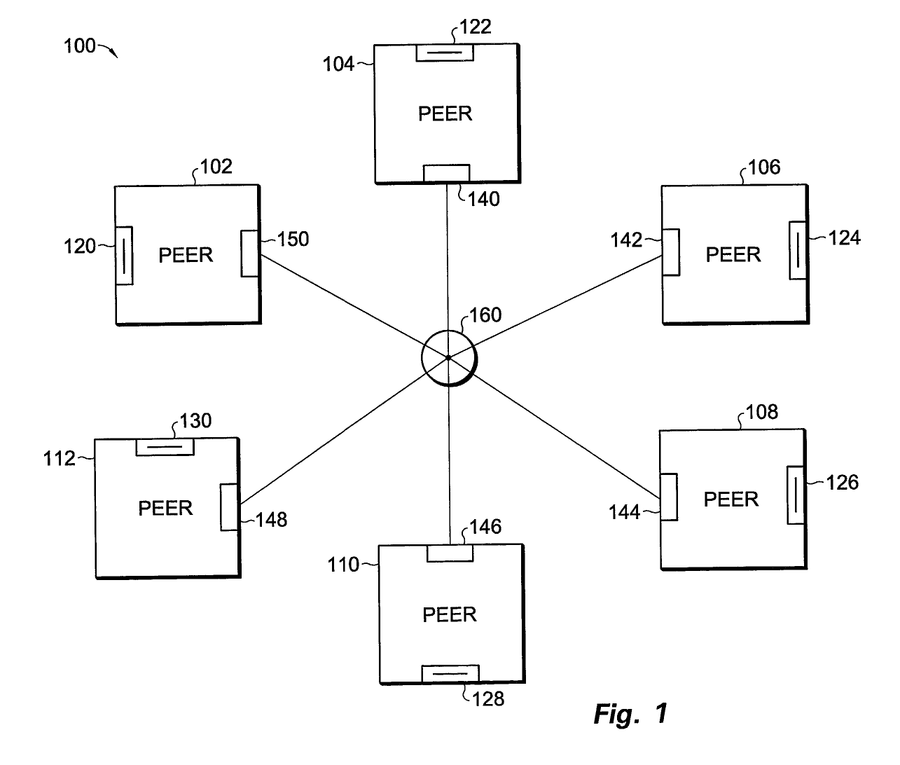

FIG. 1 depicts a peer-to-peer network 100 in accordance with an embodiment of the present invention. Peer-to-peer network 100 includes peer machines 102, 104, 106, 108, 110, and 112. Peer machines 102-112 may be computing platforms that have a memory and a processor that executes instructions stored in the memory or downloaded from another source. Peer machines 102-112 may be desktop computers, laptop computers, personal digital assistants (“PDAs”), wireless devices, servers, and the like. Peer machines 102-112 also may be known as hosts, clients, computing platforms, computing devices, server platforms, and the like. Peer machines 102-112 are coupled to each other to exchange information and data. Network infrastructure 160 facilitates the exchange of information and data between peer machines 102-112.

A feature of peer-to-peer network 100 is that peer machines 102-112 may communicate to each other without a central server. Peer machines 102112 may exchange information and provide services to each other. Peer-to-peer network 100 may be considered an open architecture network. Peer-to-peer network 100 spreads the capability of each machine into network 100 such that any server may be a client, and any client may be a server. Peer machines 102-112 may implement the peer-to-peer configuration via a peer-to-peer layer that allows communication between the different machines. The layer may include a protocol that is installed on peer machines 102-112. The layer may be installed from a central location. After installation, each peer machine, such as peer machine 102, would register with each other via the protocol. The protocol may allow peer machines 102-112 to sign in and out, as needed. Signed-in peer machines may communicate via network infrastructure 160. Preferably, network infrastructure 160 is local area network (“LAN”) based. Further, network infrastructure 160 may be a virtual LAN.

Peer machines 102-112 include various features. Peer machine 102 may include internet protocol address 120 and peer monitoring protocol 150. Peer machine 104 may include internet protocol address 122 and peer monitoring protocol 140. Peer machine 106 may include internet protocol address 124 and peer monitoring protocol 142. Peer machine 108 may include internet protocol address 126 and peer monitoring protocol 144. Peer machine 110 may include internet protocol address 128 and peer monitoring protocol 146. Peer machine 112 may include internet protocol address 130 and peer monitoring protocol 148. Peer-to-peer network 100 also may include additional peer machines having internet protocol addresses and peer monitoring protocols. All of the peer machines are able to communicate to each other via network infrastructure 160.

Internet protocol addresses 120-130 represent the identification numbers for the respective peer machines. Internet protocol addresses 120-130 identify their respective peer machines 102-112. For example, internet protocol address 124 uniquely identifies peer machine 106 to peer-to-peer network 100. Thus, data packets being sent to peer machines 102-122 should identify the machines by their internet protocol addresses.

Peer monitoring protocols 140-150 also reside on peer machines 102-112, respectively. Peer monitoring protocols 140-150 provide the monitoring capability for peer-to-peer network 100. Peer monitoring protocols 140-150 monitor by sending commands to other peer machines within network 100. These commands may be known as “ping” commands. Ping commands query a machine identified by its name and internet protocol address. In response to the ping command, the queried machine sends back a message or notification that it is “alive” or operating. If the queried machine is not operating, then no reply may be received in response to the ping command.

For example, peer machine 102 executes peer monitoring protocol 150. Peer monitoring protocol 150 sends ping commands to the other peer machines within network 100. A ping command is sent to peer machine 108 according to internet protocol address 126 and the name of peer machine 108. Alternatively, the ping command may be sent according to internet protocol address 126. The ping command is received at peer machine 108 and peer monitoring protocol 144 may respond by indicating that peer machine 108 is operational. Peer monitoring protocol 150 notes the reply from peer machine 108.

If peer machine 108 does not reply to the ping command, then peer monitoring protocol 150 may note the non-reply to peer machine 102. Corrective action may be taken by peer machine 102, such as an error message, an attempted restart of peer machine 108, and the like. Further, multiple incidents of peer machine 108 being down should be identified because ping commands are being sent by all peer machines within network 100. Moreover, no central monitoring machine is involved, and there is no possible single point of failure. Thus, if peer machine 102 also is down for some reason, then another peer machine, such as peer machine 104, should be able to report the network problems using peer monitoring protocol 140 and the ping commands.

Using peer-to-peer monitoring, peer machines 102-112 on peer-to-peer network 100 may check on each other to identify in a timely manner when a peer machine is off-line. The burden of detection, notification, and recovery is not limited to a single administrative host or hosts, but is distributed across several machines that are capable of the same tasks. The probability is increased that a peer machine is alive on network 100 to detect the problems and to take corrective action. As more peer machines are added to network, the probability of detecting the problem increases, such that there is a safety in numbers. In addition, uptime and reliability of peer machines 102-112 are increased within network 100.

Peer monitoring protocols 140-150 may send ping commands at regular intervals, such as once every fifteen minutes. The interval may be set by a system administrator. Further, peer monitoring protocols 140-150 may ping a designated subset of peer machines within network 100. Peer monitoring protocols 140-150 operate at a low level on their respective peer machines as not to interfere with other programs and applications executing on network 100. The disclosed embodiment make use of fallow or unused memory and capacity on peer machines 102-112. As existing resources sit idle, network 100 may use peer machines 102-112 to monitor each other using the peer monitoring protocols 140-150 and the ping commands. Further, new resources or hardware would not have to be installed on peer machines 102-112. Peer monitoring protocols 140-150 may be installed onto the memory on peer machines 102-112. Preferably, peer monitoring protocols 140-150 are scripts occupying about 100 kilobytes of memory.

The peer-to-peer monitoring disclosed with reference to FIG. 1 may supplement an existing system that monitors network 100. Peer-to-peer monitoring may operate as a fail-safe to the existing monitoring system. If the existing monitoring system fails, then the disclosed embodiments may take over and help identify that the peer machine is off-line or down. For example, a power flucuation may occur that crashes servers on network 100. Peer machines 110 and 112 are affected. Power has not been lost to alert the main monitoring service, but no responses were received for pings from the peer monitoring protocols. An alarm may be triggered or other alerts initiated because peer machines 110 and 112 are out.

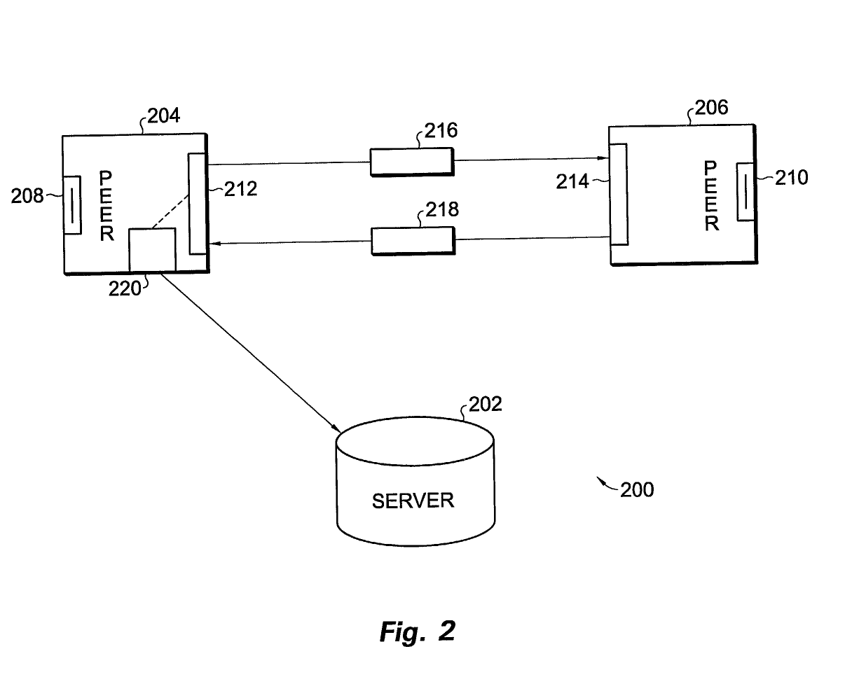

FIG. 2 depicts a network 200 performing monitoring operations in accordance with an embodiment of the present invention. Network 200 may be a peer-to-peer network corresponding to peer-to-peer network 100 disclosed in FIG. 1. Network 200 includes server 202, peer machine 204 and peer machine 206. Additional peer machines may be network 200, but are not shown. Peer machines 204 and 206 may be any computing platform having a memory and a processor to execute instructions stored in the memory or downloaded from another source. Peer machines 204 and 206 may exchange information with each other, and server 202. Server 202 is a known server, and may execute programs to manage and monitor peer machines 204 and 206. Server 202 is coupled to peer machines 204 and 206.

Peer machine 204 includes internet protocol address 208 and peer monitoring protocol 212. Peer machine 206 includes internet protocol address 210 and peer monitoring protocol 214. Peer monitoring protocols 212 and 214 may ping peer machines 206 and 204, respectively, to determine availability. Peer monitoring protocols 212 and 214 may operate in conjunction with monitoring operations from server 202.

Peer machine 204 executes peer monitoring protocol 212 and sends ping command 216 to peer machine 206. Ping command 212 may identify peer machine 206 by internet protocol address 210. Ping command 216 is received by peer monitoring protocol 214. Alternatively, ping command 216 may be received by any component of peer machine 206 that is capable of responding to ping command 216 by indicating peer machine 206 is operational, or “on.” If peer machine 206 is operational, then peer monitoring protocol 214 sends reply message 218 to peer machine 204. Reply message 214 may identify peer machine 204 by internet protocol address 208.

Reply message 218 may logged into memory location 220. Memory location 220 may be a cache memory that serves to log the status of the peer machines within network 200. As peer monitoring protocol 212 receives replies from the different peer machines, the results of the replies on saved at memory location 220. At predetermined times, such as the end of the day or close of business, the contents of memory location 220 may be downloaded to server 202 for storage and/or analysis. The reply logs of memory location 220 may be reviewed to determine the status and availability of the different peer machines on network 200.

If peer machine 206 is off-line or down, then no reply message should be received in response to ping command 216. No peer monitoring protocol 214 is able to receive ping command 216 because peer machine 206 is not operating. After an interval to respond, peer machine 204 may store the nonresponse in memory location 220 and notify server 202. Server 202 may take corrective action. Alternatively, peer machine 204 may alert a system administrator or user on network 200 that peer machine 206 is down. A page may be sent to someone to notify them of the downed peer machine 206. Peer machine 204 thus becomes a “messenger” peer machine that can alert a system administrator, notify other peer machines, and log the failure.

Peer machine 204 also may attempt to reboot or recover peer machine 206 if no reply is given to ping command 216. Further, peer machine 204 may attempt a restart of peer machine 206. Alternatively, peer machine 204 may contact another machine or component of network 200 to perform failure recovery measures. Server 202 may be notified to restart peer machine 206. Moreover, according to the disclosed embodiments, if peer machine 204 also is down, then another peer machine within network 200 may be able to detect the failure and perform failure recovery and notification.

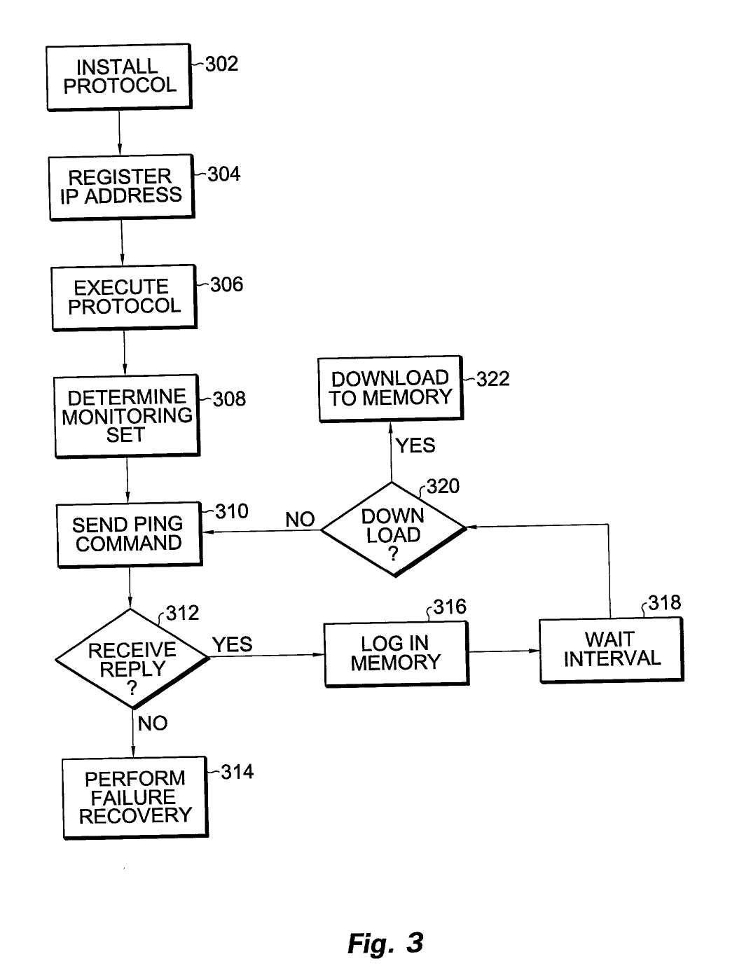

FIG. 3 depicts a flowchart for monitoring a peer-to-peer network in accordance with an embodiment of the present invention. Step 302 executes by installing peer monitoring protocols on peer machines within a network. Peer machines may be client machines, or any type of computing platform within a network that exchanges information with other computers or machines within the network. The protocol may be installed on a peer machine in any known fashion, including downloading the protocol from a remote location. Step 304 executes by registering the internet protocol address of the peer machine receiving the peer monitoring protocol with the other peer machines within the network. Alternatively, the internet protocol address may be registered with a server or other central administration application.

Step 306 executes by executing the peer monitoring protocol on the peer machine. The peer monitoring protocol may be a software program that is stored in memory on the peer machine and is comprised of instructions. Step 308 executes by determining a set of peer machines to be monitored by the peer monitoring protocols on the different peer machines within the network. Each peer machine may monitor every other peer machine in the network, or a specified subset of peer machines. The peer machines may be grouped by type, functionality, or any other criteria. Subsets of peer machines may reduce the resources desired to perform effective monitoring operations.

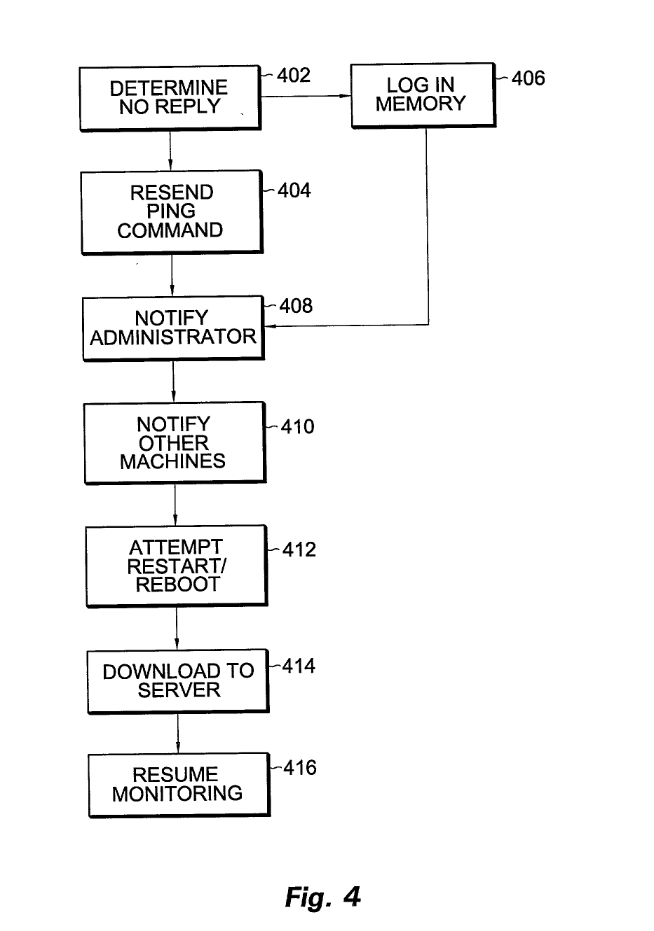

Step 310 executes by sending a ping command to each peer machine within the set of peer machines to be monitored. The peer monitoring protocol may send a ping command by using the peer machine's name and internet protocol address. The ping command queries whether the pinged machine is on, or “alive.” Ping commands may be sent using an existing ability to ping machines, such as Unix commands. Step 312 executes by determining whether a reply was received to the ping command. If a peer machine is on, the peer machine should reply back to the querying peer machine. If not, then no reply should be sent. If step 312 is no, then step 314 executes by performing failure recovery operations. The failure recovery operations are disclosed in greater detail above and with reference to FIG. 4.

If step 312 is yes, then step 316 executes by logging the reply from the queried peer machine into memory at the sending peer machine. “Memory” includes any type of data storage, and, preferably, is a memory location within the peer machine. Alternatively, memory may be a disk or other rewritable memory. By logging the replies from the pinged peer machines, a system administrator or other interested party may go to any live machine and receive a report on the network. This feature may be important in the event of a machine failure. For example, a proxy server may fail and this event prevents access to the web servers to determine if they have failed. According to the disclosed embodiments, a peer machine that is operational should have information on the status of the other machines and components of the network.

Step 318 executes by waiting an interval before resuming operations. This step may be optional, but the network may desire a delay before sending ping commands. This feature prevents the monitoring process from unnecessarily filling the network with message traffic. Further, the delay may allow any additional checks or recovery actions to take place. The interval should be predetermined, and may be set on a network level. Alternatively, the interval may be set on a component or machine level. The preferred delay is fifteen minutes.

Step 320 executes by determining whether the reply log stored in the memory should be downloaded to a server or other central location. A download may occur at the end of the business day, or any other predetermined time. If no, then step 310 executes as disclosed above. If no, then step 322 executes by downloading the log file to a specified location, such as a central monitoring server.

FIG. 4 depicts a flowchart for failure recovery in accordance with an embodiment of the present invention. FIG. 4 may correlate with step 314 of FIG. 3. Step 314, however, is not limited by the disclosure with reference to FIG. 4. Step 402 executes by determining no reply was received from a queried peer machine on a network. Step 404 executes by resending a ping command to the nonresponsive machine. The ping command may be sent as disclosed above. The ping command is resent because a network error or other minor error may have prevented the reply message from being received at the sending peer machine. Step 406 executes by logging in memory that a reply was not received in response to the ping command. The time of the sent ping command and the internet protocol address of the nonresponsive machine may be saved in the memory for record keeping purposes.

Step 408 executes by notifying a network or systems administrator about the failure condition. Preferably, the administrator is someone who monitors and supports the network. A page, email message, or any method of notifying the administrator is applicable in this instance. Alternatively, the administrator may be a server or other central monitoring component of the network. Step 410 executes by notifying the other peer machines and components on the network that the queried peer machine is down. All components of the network may update their records as to the failure condition and take appropriate action. For example, the failed machine may be removed from the monitor list to receive ping commands.

Step 412 executes by attempting to restart or reboot the failed peer machine from another peer machine or component in the network. The sending peer machine may attempt recovery operations. Step 414 executes by downloading the failure information to a server or other central monitoring component in the network. The log file from the memory on a peer machine may be downloaded. Alternatively, the failure information may be downloaded reduce network traffic. Step 416 executes by resuming monitoring of the network by sending ping commands using the peer monitoring protocol.

Thus, a system and method for monitoring a peer-to-peer network is disclosed. The disclosed features allow a network to increase its availability and efficiency. Further, the network's responsiveness to failed components is increased by distributing the monitoring responsibilities throughout the network. The disclosed embodiments may supplement an existing monitoring system without impeding network operations or increasing traffic on the network. If a machine fails on the network, a system administrator may be notified in a more timely manner and recovery operations undertaken without additional customer complaints.

It will be apparent to those skilled in the art that various modifications and variations can be made in the wheel assembly of the present invention without departing from the spirit or scope of the invention. Thus, it is intended that the present invention covers the modifications and variations of this invention provided that they come within the scope of any claims and their equivalents.

What is claimed:

1. A system for monitoring a network having a plurality of peer machines, comprising:
a peer machine from said plurality of peer machines having a peer monitoring protocol;
a ping command, wherein said peer machine sends said ping command to said plurality of peer machines; and
a failure recovery state for said peer machine that is implemented according to said ping command.

2. The system of claim 1, wherein said peer machine is a computer.

3. The system of claim 1, further comprising a reply message received at said peer machine in response to said ping command.

4. The system of claim 3, further comprising a normal state that is implemented according to said reply message.

5. The system of claim 1, wherein said failure recovery state includes a failure message sent to said plurality of peer machines.

6. The system of claim 1, wherein said failure recovery state includes a failure message sent to a server within said network and coupled to said peer machine.

7. The system of claim 1, further comprising a memory location within said peer machine to log said ping command.

8. A system for monitoring a peer-to-peer network that exchanges information between a plurality of peer machines, comprising:
a ping command to query a status of at least one of said plurality of peer machines; and
a peer monitoring protocol to send said ping command and to enter a state according to a response to said ping command.

9. The system of claim 8, wherein said state is a failure state when said response to said ping command is no reply from at least one peer machine.

10. The system of claim 8, wherein said state is a normal state when said response to said ping command is a reply message from said at least one peer machine.

11. The system of claim 8, further comprising a server within said peer-to-peer network.

12. The system of claim 8, further comprising a querying peer machine that hosts said peer monitoring protocol.

13. The system of claim 12, wherein said querying peer machine includes a memory location to store said response to said ping command.

14. The system of claim 13, further comprising a server coupled to said querying peer machine to download a data file from said memory location.

15. The system of claim 12, wherein said querying peer machine is a computer comprising a processor and a memory coupled to said processor, wherein said processor executes instructions stored in said memory to execute said peer monitoring protocol.

16. A peer-to-peer network for exchanging information between peer machines, comprising:
a first peer machine having a memory location;
a second peer machine coupled to said first peer machine over said network;
a peer monitoring protocol on said first peer machine to send a ping command to said second peer machine, wherein said ping command queries whether said second peer machine is available; and
a reply message responsive to said ping command when said second peer machine is available.

17. The peer-to-peer network of claim 16, wherein said memory location logs said reply message from said second peer machine.

18. The peer-to-peer network of claim 16, further comprising a server to download a data file from said memory location.

19. The peer-to-peer network of claim 16, wherein said ping command includes an internet protocol address of said second peer machine.

20. A method for monitoring a peer-to-peer network, comprising:
executing a peer monitoring protocol on a first peer machine within said network;
sending a ping command to a second peer machine from said peer monitoring protocol; and
determining whether said second peer machine is available according to a response from said ping command.

21. The method of claim 20, further comprising performing failure recovery operations when said second peer machine is not available.

22. The method of claim 21, wherein said performing includes restarting said second peer machine.

23. The method of claim 21, wherein said performing includes rebooting said second peer machine.

24. The method of claim 21, wherein said performing includes notifying said network that said second peer machine is unavailable.

25. The method of claim 21, wherein said performing includes notifying a system administrator that said second peer machine is unavailable.

26. The method of claim 20, further comprising storing said response within a memory location on said first peer machine.

27. The method of claim 26, further comprising downloading a data file from said memory location to another component within said network.

28. The method of claim 27, wherein said another component is a server.

29. The method of claim 20, further comprising delaying a predetermined interval before sending another ping command from said peer monitoring protocol.

30. The method of claim 20, wherein said sending includes determining an internet protocol address for said second peer machine.

31. A method for monitoring a network having peer machines, wherein said peer machines perform peer-to-peer information exchange over said network, comprising:
executing peer monitoring protocols on each of said peer machines to send ping commands from said each of said peer machines;
receiving said ping commands at said peer machines;
responding to said ping commands by available peer machines;
not responding to said ping commands by nonavailable peer machines; and
performing failure recovery operation on said nonavailable peer machines.

32. The method of claim 32, further comprising sending said ping commands from said peer monitoring protocols.

33. The method of claim 32, wherein said sending includes sending said ping commands according to internet protocol addresses of said peer machines.

34. The method of claim 31, further comprising downloading data files from said available peer machines.

35. The method of claim 32, further comprising waiting a predetermined interval.

36. The method of claim 35, further comprising resending said ping commands.

37. A method for detecting a offline peer machine within a peer-to-peer network of peer machines, comprising:
sending a ping command from a peer monitoring protocol on a querying peer machine;
receiving no response from said offline peer machine at said querying peer machine; and
notifying said network that said offline peer machine is unavailable.

38. The method of claim 37, further comprising resending said ping command to said offline peer machine.

39. The method of claim 37, further comprising restarting said offline peer machine.

40. The method of claim 37, wherein said notifying includes notifying a system administrator that said offline peer machine is unavailable.

41. The method of claim 37, further comprising logging to a memory location that said offline peer machine is unavailable.

42. The method of claim 37, further comprising rebooting said offline peer machine.

43. The method of claim 37, wherein said sending includes sending said ping command to said offline peer machine according to an internet protocol address.

44. A system for monitoring a peer-to-peer network, comprising:
means for executing a peer monitoring protocol on a first peer machine within said network;
means for sending a ping command to a second peer machine from said peer monitoring protocol; and
means for determining whether said second peer machine is available according to a response from said ping command.

45. A system for monitoring a network having peer machines, wherein said peer machines perform peer-to-peer information exchange over said network, comprising:
means for executing peer monitoring protocols on each of said peer machines to send ping commands from said each of said peer machines;
means for receiving said ping commands at said peer machines;
means for responding to said ping commands by available peer machines;
means for not responding to said ping commands by nonavailable peer machines; and
means for performing failure recovery operation on said nonavailable peer machines.

46. A system for detecting a offline peer machine within a peer-to-peer network of peer machines, comprising:
means for sending a ping command from a peer monitoring protocol on a querying peer machine;
means for receiving no response from said offline peer machine at said querying peer machine; and
means for notifying said network that said offline peer machine is unavailable.
